(19) United States
(12) Patent Application Publication
(10) Pub. No.: US 2006/0223960 A1
(43) Pub. Date: Oct. 5, 2006

(54) Modified (MAO + aluminum alkyl) activator

(75) Inventors: Isam Jaber, Calgary (CA); John William Swabey, Calgary (CA); Xiaoliang Gao, Calgary (CA); Charles Ashton Garret Carter, Calgary (CA); Cliff Robert Baar, Calgary (CA)

Correspondence Address: Kenneth H. Johnson;Patent Attorney, P.O. Box 630708, Houston, TX, 77263, US

(73) Assignee: NOVA Chemicals (International) S.A.

(21) Appl. No.: 11/364,248

(22) Filed: Feb. 28, 2006

(30) Foreign Application Priority Data
Apr. 1, 2005 (CA) 2,503,461

(51) Int. Cl. C08F 4/44

(52) U.S. Cl. 526/153; 526/160; 526/943

(57) ABSTRACT

A cocatalyst system for olefin polymerization comprises an aluminoxane (especially methylaluminoxane, or “MAO”), an aluminum alkyl and a halogenated phenol. The preferred halogenated phenol is pentafluorophenol. The use of pentafluorophenol permits the substitution of a portion of the MAO cocatalyst (which is expensive) with inexpensive aluminum alkyl. The cocatalyst is most preferably employed in combination with an organometallic catalyst having at lease one pi ligand.

### FIELD OF THE INVENTION

This invention relates to a cocatalyst for olefin polymerization.

### BACKGROUND OF THE INVENTION

This invention relates to olefin polymerizations.

It is now well known to use an aluminoxane, especially a methylaluminoxane, to activate olefin polymerization catalysts containing group 3-10 metal complexes (particularly those metal complexes which contain delocalized pi ligands and are known as “metallocene catalysts”).

Organoboron activators are also known for olefin polymerization. However, these activators are expensive.

Accordingly, it would be desirable to improve the performance of prior art activators, especially with respect to lowering the cost of the activators.

### SUMMARY OF THE INVENTION

The present invention provides a catalyst activator comprising a cocatalyst system for olefin polymerization comprising:

1) methylaluminoxane having a molar aluminum concentration of A1;

2) additional aluminum alkyl in a molar amount A2, wherein said aluminum alkyl is defined by the formula Al(R)ₐ(OR)_{b}X_{c};
wherein each R and R¹ is a C_{1 to 10} hydrocarbyl;
X is a halide; and
a+b+c=3 with the provisos that a≧1 and A2<A1; and

3) a halogenated phenol.

In a preferred embodiment, the halogenated phenol is present in a molar amount hP1 defined by the formula:
0.45A1+3A2≧hP1>0.25A1

With reference to the above formula, the preferred maximum amount of halogenated phenol (in moles) is given by the sum of:

1) (0.45)×(moles of MAO)+

2) (3)×(moles of alkyl aluminum).

The preferred minimum amount of halogenated phenol (in moles) is (0.25)×(moles of MAO).

It is especially preferred that the amount of halogenated phenol is at least 0.4 moles per mole of aluminum in the MAO plus aluminum alkyl.

The activator of this invention is particularly useful for the polymerization of addition polymerizable monomers (especially monoolefins) in the presence of a transition metal catalyst. Catalysts based on group 4 metals are preferred. Thus, another embodiment of this invention provides a catalyst system comprising a catalyst system for olefin polymerization comprising (A) a group 3-10 metal catalyst; and (B) a catalyst activation system comprising a cocatalyst system for olefin polymerization comprising:

1) methylaluminoxane having a molar aluminum concentration of A1;

2) additional aluminum alkyl in a molar amount A2, wherein said aluminum alkyl is defined by the formula Al(R)ₐ(OR)_{b}X_{c};
wherein each R and R¹ is a C_{1 to 10} hydrocarbyl;
X is a halide; and
a+b+c=3 with the provisos that a≧1 and A2<A1; and

3) a halogenated phenol;
preferably, wherein said halogenated phenol is present in a molar amount hP1 defined by the formula:
   0.45A1+3A2≧hP1≧0.25A1

A third embodiment of this invention provides a process for the polymerization of olefins, especially C₂ to C₈ alpha olefins, using the catalyst of this invention.

### DETAILED DESCRIPTION OF PREFERRED EMBODIMENTS

The activator of this invention comprises three essential components which are described in detail below.

1. “MAO”, Including Modified MAO

Aluminoxanes are well known activators for olefin polymerization. Although the exact structure of many aluminoxanes is still the subject of debate, it is generally accepted by those skilled in the art that aluminoxanes are oligomeric compounds which contain subunits defined by the formula: 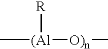
where R is an alkyl group and n is from 5 to 10. The aluminoxane used in this invention is methylaluminoxane and/or “MAO”, in which the R group of the above formula is predominantly (>75 mole %) methyl. That is, the invention also contemplates the use of “modified MAO” (in which a small percentage—less than 25 mole %—of the R groups may be one or more C_{2 to 8} alkyls, especially isobutyl).

MAO may be prepared by the hydrolysis of trimethyl aluminum (and “modified” MAO suitable for this invention may be prepared by the hydrolysis of a mixture of trimethyl aluminum with a minor amount of one or more higher aluminum alkyls, modified “MAO” is preferred, such as triisobutyl aluminum).

Thus, the “modified MAO” which is preferably used in this invention might be described as an oligomer which contains the following subunits: 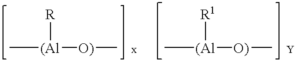
wherein R is methyl, R¹ is a C₂ to C₈ alkyl; x+y=5 to 10; and x/y>3/1. It will be recognized by those skilled in the art that MAO typically contains associated trimethyl aluminum (TMA) in addition to the oligomeric structure. In general, the molar ratio of [aluminum contained in the associated TMA]:[aluminum in oligomeric structure] is from about 1:10 to 1:4.
2. Alkyl Aluminum

The cocatalyst system of this invention contains “additional” aluminum alkyl—i.e. extra aluminum alkyl which is added to the MAO. The term “additional” is used for clarity—i.e. to reinforce that this added aluminum alkyl is “in addition to” the “associated” TMA which is described above. The additional aluminum alkyl is defined by the formula:
Al(R)ₐ(OR¹)_{b}X_{c}
wherein R and R¹ is independently a C₁ to C₁₀ hydrocarbyl group; X is a halide; a+b+c=3, with the proviso that a≧1.

Preferred aluminum alkyls are trialkyl aluminum compounds selected from the group consisting of trimethyl aluminum, triethyl aluminum and triisobutyl aluminum.

The amount of aluminum alkyl used in this invention is expressed on a molar basis with respect to the “total” amount of aluminum contained in the MAO.

More specifically the molar amount additional aluminum (hereinafter “Al2”) is less than the total molar amount of aluminum contained in the MAO (hereinafter “Al1”). For clarity, the total molar amount of aluminum contained in the MAO includes both of (a) the aluminum contained in the oligomeric units; and (b) the aluminum contained in the free TMA.

The preferred range of Al2:Al1 molar ratios is from about 0.05/1 to 0.5/1, especially from 0.1/1 to 0.4/1.

The total aluminum/transition metal molar ratio is preferably from 50/1 to 4,000/1, especially from 100/1 to 3,000/1.

3. Halogenated Phenols

As used herein, the term halogenated phenol is meant to include those compounds which contain a six membered aromatic ring structure and a hydroxyl group, with at least one halogen substituent. In addition, to the halogen substituent, the halogenated phenol may also contain a hydrocarbyl substituent such as an alkyl group, a branched alkyl group or another ring structure. The preferred halogen substituents are chlorine and fluorine with fluorine being particularly preferred. Highly halogenated phenols are especially preferred—particularly pentachlorophenol and pentafluorophenol.

The amount of halogenated phenol used also influences the success of this invention. The optimal amount may be readily determined by routine experiments.

As previously noted, the preferred minimum amount of halogenated phenol (expressed as a molar basis) is preferably at least 0.25 moles per mole of aluminum contained in the MAO, with at least 0.4 moles per mole of aluminum in the MAO and aluminum alkyl being especially preferred.

Some care must be employed to avoid the use of an excessive amount of halogenated phenol (as this may be detrimental to catalyst activity).

A preferred maximum amount of halogenated phenol is given by the further addition of up to 3 moles of phenol per mole of additional aluminum alkyl. These two preferred conditions are defined by the equation:
0.45A1+3A2≧hP1≧0.25A1
wherein

hP1=amount of halogenated phenol, moles

A1=total amount of aluminum in MAO, moles

A2=amount of “additional” aluminum from aluminum alkyl, moles

Catalyst

Particularly preferred catalysts are group 4 metal catalysts defined by the formula: 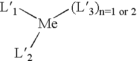
wherein Mₑ is selected from titanium, hafnium and zirconium; each L′₃ is an activatable ligand; L′₁ and L′₂ are independently selected from the group consisting of cyclopentadienyl, substituted cyclopentadienyl (including indenyl and fluorenyl) and heteroatom ligands, with the proviso that L′₁ and L′₂ may optionally be bridged together so as to form a bidentate ligand. It is further preferred that n=2 (i.e. that there are 2 monoanionic activatable ligands).

As previously noted, each of L′₁ and L′₂ may independently be a cyclopentadienyl ligand or a heteroatom ligand. Preferred catalysts include metallocenes (where both L′₁ and L′₂ are cyclopentadienyl ligands which may be substituted and/or bridged) and monocyclopentadienyl heteroatom catalysts (especially a catalyst having a cyclopentadienyl ligand and a phosphinimine ligand), as illustrated in the Examples. Brief descriptions of exemplary ligands are provided below.

Cyclopentadienyl Ligands

L′₁ and L′₂ may each independently be a cyclopentadienyl ligand. As used herein, the term cyclopentadienyl ligand is meant to convey its broad meaning, namely a substituted or unsubstituted ligand having a five carbon ring which is bonded to the metal via eta-5 bonding. Thus, the term cyclopentadienyl includes unsubstituted cyclopentadienyl, substituted cyclopentadienyl, unsubstituted indenyl, substituted indenyl, unsubstituted fluorenyl and substituted fluorenyl. An exemplary list of substituents for a cyclopentadienyl ligand includes the group consisting of C₁₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R¹)₃ wherein each R¹ is independently selected from the group consisting of hydrogen, a C₁₋₈ alkyl or alkoxy radical C₆₋₁₀ aryl or aryloxy radicals; germanyl radicals of the formula Ge—(R¹)₃ wherein R¹ is as defined directly above.

Activatable Ligand

Each L′₃ is an activatable ligand. The term “activatable ligand” refers to a ligand which may be activated by a cocatalyst or “activator” (e.g. the aluminoxane) to facilitate olefin polymerization. Exemplary activatable ligands are independently selected from the group consisting of a hydrogen atom, a halogen atom, a C₁₋₁₀ hydrocarbyl radical, a C₁₋₁₀ aryl or aryloxy radical, an amido radical which is unsubstituted or substituted by up to two C₁₋₈ alkyl radicals; a phosphido radical which is unsubstituted or substituted by up to two C₁₋₈ alkyl radicals.

The number of activatable ligands depends upon the valency of the metal and the valency of the activatable ligand. As previously noted, the preferred catalysts contain a group 4 metal in the highest oxidation state (i.e. 4+) and the preferred activatable ligands are monoanionic (such as a halide—especially chloride, or an alkyl—especially methyl). Thus the preferred catalyst contains two activatable ligands. In some instances, the metal of the catalyst component may not be in the highest oxidation state. For example, a titanium (III) component would contain only one activatable ligand. Also, it is permitted to use a dianionic activatable ligand although this is not preferred.

Heteroatom Ligands

As used herein, the term heteroatom ligand refers to a ligand which contains a heteroatom selected from the group consisting of nitrogen, boron, oxygen, phosphorus and sulfur. The ligand may be sigma or pi bonded to the metal. Exemplary heteroatom ligands include phosphinimine ligands, ketimide ligands, siloxy ligands amido ligands, alkoxy ligands, boron heterocyclic ligands and phosphole ligands. Brief descriptions of such ligands follow:

Phosphinimine Ligand

Phosphinimine ligands are defined by the formula: 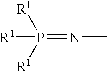
wherein each R¹ is independently selected from the group consisting of a hydrogen atom, a halogen atom, a C₁₋₈ alkoxy radical, one C₆₋₁₀ aryl or aryloxy radical, an amido radical, a silyl radical of the formula:
—Si—(R²)₃
wherein each R² is independently selected from the group consisting of hydrogen, a C₁₋₈ alkyl or alkoxy radical, C₆₋₁₀ aryl or aryloxy radicals, and a germanyl radical of the formula:
Ge—(R²)₃
wherein each R² is independently selected from the group consisting of hydrogen, a C₁₋₈ alkyl or alkoxy radical, C₆₋₁₀ aryl or aryloxy radicals, and a germanyl radical of the formula:
Ge—(R²)₃
wherein each R² is as defined above.

The preferred phosphinimines are those in which each R¹ is a hydrocarbyl radical. A particularly preferred phosphinimine is tri-(tertiary butyl)phosphinimine (i.e. where each R¹ is a tertiary butyl group).

Ketimide Ligands

As used herein, the term “ketimide ligand” refers to a ligand which:

a) is bonded to the group 4 metal via a metal-nitrogen atom bond;

b) has a single substituent on the nitrogen atom, (where this single substituent is a carbon atom which is doubly bonded to the N atom); and

c) has two substituents (Sub 1 and Sub 2, described below) which are bonded to the carbon atom.

Conditions a, b and c are illustrated below:

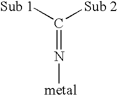

The substituents “Sub 1” and “Sub 2” may be the same or different. The substituents may be bonded together—i.e. it is permissible to include a bond which bridges Sub 1 and Sub 2. Exemplary substituents include hydrocarbyls having from 1 to 20 carbon atoms, silyl groups, amido groups and phosphido groups. For reasons of cost and convenience it is preferred that these substituents both be hydrocarbyls, especially simple alkyls and most preferably tertiary butyl.

Siloxy Heteroligands

These ligands are defined by the formula:
-(μ)SiRₓR_{y}R_{z}
where the — denotes a bond to the transition metal and μ is sulfur or oxygen.

The substituents on the Si atom, namely Rₓ, R_{y} or R_{z} is not especially important to the success of this invention. It is preferred that each of Rₓ, R_{y} and R_{z} is a C₁₋₄ hydrocarbyl group such as methyl, ethyl, isopropyl or tertiary butyl (simply because such materials are readily synthesized from commercially available materials).

Amido Ligands

The term “amido” is meant to convey its broad, conventional meaning, Thus, these ligands are characterized by (a) a metal-nitrogen bond; and (b) the presence of two substituents (which are typically simply alkyl or silyl groups) on the nitrogen atom.

Alkoxy Ligands

The term “alkoxy” is also intended to convey its conventional meaning. Thus these ligands are characterized by (a) a metal oxygen bond; and (b) the presence of a hydrocarbyl group bonded to the oxygen atom. The hydrocarbyl group may be a ring structure and/or substituted (e.g. 2,6 di-tertiary butyl phenoxy).

Boron Heterocyclic Ligands

These ligands are characterized by the presence of a boron atom in a closed ring ligand. This definition includes heterocyclic ligands which also contain a nitrogen atom in the ring. These ligands are well known to those skilled in the art of olefin polymerization and are fully described in the literature (see, for example U.S. Pat. Nos. 5,637,659; 5,554,775 and the references cited therein).

Phosphole Ligands

The term “phosphole” is also meant to convey its conventional meaning. “Phosphole” is also meant to convey its conventional meaning. “Phospholes” are cyclic dienyl structures having four carbon atoms and one phosphorus atom in the closed ring. The simplest phosphole is C₄PH₄ (which is analogous to cyclopentadiene with one carbon in the ring being replaced by phosphorus). The phosphole ligands may be substituted with, for example, C₁₋₁₂₀ hydrocarbyl radicals (which may, optionally, contain halogen substituents), phosphido radicals, amido radicals, silyl or alkoxy radicals.

Phosphole ligands are also well known to those skilled in the art of olefin polymerization and are described as such in U.S. Pat. No. 5,431,116 (Sone to Tosoh).

Polymerization Processes

This invention is suitable for use in any conventional olefin polymerization process, such as the so-called “gas phase”, “slurry”, “high pressure” or “solution” polymerization processes. Polyethylene, polypropylene and ethylene propylene elastomers are examples of olefin polymers which may be produced according to this invention.

The preferred polymerization process according to this invention uses ethylene and may include other monomers which are copolymerizable therewith such as other alpha olefins (having from three to ten carbon atoms, preferably butene, hexene or octene) and, under certain conditions, dienes such as hexadiene isomers, vinyl aromatic monomers such as styrene or cyclic olefin monomers such as norbornene.

The present invention may also be used to prepare elastomeric co- and terpolymers of ethylene, propylene and optionally one or more diene monomers. Generally, such elastomeric polymers will contain about 50 to about 75 weight % ethylene, preferably about 50 to 60 weight % ethylene and correspondingly from 50 to 25% of propylene. A portion of the monomers, typically the propylene monomer, may be replaced by a conjugated diolefin. The diolefin may be present in amounts of up to 10 weight % of the polymer although typically is present in amounts from about 3 to 5 weight %. The resulting polymer may have a composition comprising from 40 to 75 weight % of ethylene, from 50 to 15 weight % propylene and up to 10 weight % of a diene monomer to provide 100 weight % of the polymer. Preferred but not limiting examples of the dienes are dicyclopentadiene, 1,4-hexadiene, 5-methylene-2-norbornene, 5-ethylidene-2-norbornene and 5-vinyl-2-norbornene. Particularly preferred dienes are 5-ethylidene-2-norbornene and 1,4-hexadiene.

The polyethylene polymers which may be prepared in accordance with the present invention typically comprise not less than 60, preferably not less than 70 weight % of ethylene and the balance one ore more C₄₋₁₀ alpha olefins, preferably selected from the group consisting of 1-butene, 1-hexene and 1-octene. The polyethylene prepared in accordance with the present invention might also be useful to prepare polyethylene having a density below 0.910 g/cc—the so-called very low and ultra low density polyethylenes.

The supported form of the catalyst system of this invention is preferably used in a slurry polymerization process or a gas phase polymerization process.

The typical slurry polymerization process uses total reactor pressures of up to about 50 bars and reactor temperature of up to about 200° C. The process employs a liquid medium (e.g. an aromatic such as toluene or an alkane such as hexane, propane or isobutane) in which the polymerization takes place. This results in a suspension of solid polymer particles in the medium. Loop reactors are widely used in slurry processes. Detailed descriptions of slurry polymerization processes are widely reported in the open and patent literature.

In general, a fluidized bed gas phase polymerization reactor employs a “bed” of polymer and catalyst which is fluidized by a flow of monomer which is at least partially gaseous. Heat is generated by the enthalpy of polymerization of the monomer is then re-circulated through the polymerization zone together with “make-up” monomer to replace that which was polymerized on the previous pass. As will be appreciated by those skilled in the art, the “fluidized” nature of the polymerization bed helps to evenly distribute/mix the heat of reaction and thereby minimize the formation of localized temperature gradients (or “hot spots”). Nonetheless, it is essential that the heat of reaction be properly removed so as to avoid softening or melting of the polymer (and the resultant-and highly undesirable—“reactor chunks”). The obvious way to maintain good mixing and cooling is to have a very high monomer flow through the bed. However, extremely high monomer flow causes undesirable polymer entrainment.

An alternative (and preferable) approach to high monomer flow is the use of an inert condensable fluid which will boil in the fluidized bed (when exposed to the enthalpy of polymerization), then exit the fluidized bed as a gas, then come into contact with a cooling element which condenses the inert fluid. The condensed, cooled fluid is then returned to the polymerization zone and the boiling/condensing cycle is repeated.

The above-described use of a condensable fluid additive in a gas phase polymerization is often referred to by those skilled in the art as “condensed mode operation” and is described in additional detail in U.S. Pat. No. 4,543,399 and U.S. Pat. No. 5,352,749. As noted in the '399 reference, it is permissible to use alkanes such as butane, pentanes or hexanes as the condensable fluid and amount of such condensed fluid preferably does not exceed about 20 weight per cent of the gas phase.

Other reaction conditions for the polymerization of ethylene which are reported in the '399 reference are:

Preferred Polymerization Temperatures: about 75° C. to about 115° C. (with the lower temperatures being preferred for lower melting copolymers—especially those having densities of less than 0.915 g/cc—and the higher temperatures being preferred for higher density copolymers and homopolymers); and

Pressure: up to about 1000 psi (with a preferred range of from about 100 to 350 psi for olefin polymerization).

The '399 reference teaches that the fluidized bed process is well adapted for the preparation of polyethylene but further notes that other monomers may be employed—as is the case in the polymerization process of this invention.

Highly preferred group 4 metal catalysts contain at least one delocalized pi ligand (such as a cyclopentadienyl ligand which may be substituted) and/or a phosphinimine ligand.

Solution processes for the copolymerization of ethylene and an alpha olefin having from 3 to 12 carbon atoms are well known in the art. These processes are conducted in the presence of an inert hydrocarbon solvent typically a C₅₋₁₂ hydrocarbon which may be unsubstituted or substituted by a C₁₋₄ alkyl group, such as pentane, methyl pentane, hexane, heptane, octane, cyclohexane, methylcyclohexane and hydrogenated naphtha. An example of a suitable solvent which is commercially available is “Isopar E” (C₈₋₁₂ aliphatic solvent, Exxon Chemical Co.). Polymerization temperatures may range from about 30° C. to about 280° C. (with lower temperatures being preferred for elastomers and higher temperatures being preferred for high density polyethylene).

Preferred solution polymerization processes use at least two polymerization reactors. The polymer solution exiting from the first reactor is preferably transferred to the second polymerization (i.e. the reactors are most preferably arranged “in series” so that polymerization in the second reactor occurs in the presence of the polymer solution from the first reactor).

The polymerization temperature in the first reactor is preferably from about 80° C. to about 180° C. (preferably from about 120° C. to 160° C.) and the second reactor is preferably operated at a higher temperature. Cold feed (i.e. chilled solvent and/or monomer) may be added to both reactors or to the first reactor only. The polymerization enthalpy heats the reactor. The polymerization solution which exits the reactor may be more than 100° C. hotter than the reactor feed temperature. The polymerization reactor(s) are preferably “stirred reactors” (i.e. the reactors are extremely well mixed with a good agitation system). Agitation efficiency may be determined by measuring the reactor temperature at several different points. The largest temperature difference (i.e. between the hottest and coldest temperature measurements) is described as the internal temperature gradient for the polymerization reactor. A very well mixed polymerization reactor has a maximum internal temperature gradient of less than 10° C. A particularly preferred agitator system is described in co-pending and commonly assigned U.S. Pat. No. 6,024,483. Preferred pressures are from about 500 psi to 8,000 psi. The most preferred reaction process is a “medium pressure process”, which means that the pressure in each reactor is preferably less than about 6,000 psi (about 42,000 kilopascals or kPa), and most preferably from about 1,500 psi to 3,000 psi (about 14,000-22,000 kPa).

Suitable monomers for copolymerization with ethylene include C₃₋₁₂ alpha olefins which are unsubstituted or substituted by up to two C₁₋₆ alkyl radicals. Illustrative non-limiting examples of such alpha-olefins are one or more of propylene, 1-butene, 1-pentene, 1-hexene, 1-octene and 1-decene. Octene-1 is highly preferred.

The monomers are dissolved/dispersed in the solvent either prior to being fed to the first reactor (or for gaseous monomers the monomer may be fed to the reactor so that it will dissolve in the reaction mixture). Prior to mixing, the solvent and monomers are generally purified to remove potential catalyst poisons such as water, oxygen or other polar impurities. The feedstock purification follows standard practices in the art, e.g. molecular sieves, alumina beds and oxygen removal catalysts are used for the purification of monomers. The solvent itself as well (e.g. methyl pentane, cyclohexane, hexane or toluene) is preferably treated in a similar manner. The feedstock may be heated or cooled prior to feeding to the first reactor. Additional monomers and solvent may be added to the second reactor, and it may be heated or cooled.

Generally, the catalyst components may be premixed in the solvent for the reaction or fed as separate streams to each reactor. In some instances premixing may be desirable to provide a reaction time for the catalyst components prior to entering the reaction. Such an “in line mixing” technique is described the patent literature (most notably U.S. Pat. No. 5,589,555, issued Dec. 31, 1996 to DuPont Canada Inc.). The residence time in each reactor will depend on the design and the capacity of the reactor. Generally the reactors should be operated under conditions to achieve a thorough mixing of the reactants. In addition, it is preferred (for dual reactor operations) that from 20 to 60 weight % of the final polymer is polymerized in the first reactor, with the balance being polymerized in the second reactor. As previously noted, the polymerization reactors are preferably arranged in series (i.e. with the solution from the first reactor being transferred to the second reactor). In a highly preferred embodiment, the first polymerization reactor has a smaller volume than the second polymerization reactor. On leaving the reactor system the solvent is removed and the resulting polymer is finished in a conventional manner.

Further details are provided by the following non-limiting examples.

### EXAMPLES

### Example A

### Comparative, Lab Scale Continuous Solution Polymerization

All the polymerization experiments described below were conducted on a continuous solution polymerization reactor. The process is continuous in all feed streams (solvent, monomers and catalyst) and in the removal of product. All feed streams were purified prior to the reactor by contact with various absorption media to remove catalyst killing impurities such as water, oxygen and polar materials as is known to those skilled in the art. All components were stored and manipulated under an atmosphere of purified nitrogen.

All the examples below were conducted in a reactor of about 70 cc internal volume. In each experiment the volumetric feed to the reactor was kept constant and as a consequence so was the reactor residence time.

The catalyst solutions were pumped to the reactor independently and there was no pre-contact between the activator and the catalyst. Cyclohexane and xylene were purified before use. MAO was prepared in cyclohexane. The catalyst and halogenated phenol (modifiers) were prepared, separately, in xylene because of low solubility. The catalyst was activated in situ (in the polymerization reactor) at the reaction temperature in the presence of the monomers. The polymerizations were carried out in cyclohexane at a pressure of 1,500 psi. Ethylene was supplied by a calibrated thermal mass flow meter directly to the reactor or was dissolved in the reaction solvent prior to the polymerization reactor. If comonomer (for example 1-octene) was used it was also premixed with the ethylene before entering the polymerization reactor, or supplied directly to the reactor. Under these conditions the ethylene conversion is a dependent variable controlled by the catalyst concentration, reaction temperature and catalyst activity, etc.

The internal reactor temperature is monitored by a thermocouple in the polymerization medium and can be controlled at the required set point to ±0.5° C. Downstream of the reactor the pressure was reduced from the reaction pressure (1,500 psi) to atmospheric. The solid polymer was then recovered as a slurry in the condensed solvent and was dried by evaporation before analysis.

The ethylene conversion was determined by a dedicated on-line gas chromatograph by reference to propane, which was used as an internal standard. The average polymerization rate constant was calculated based on the reactor hold-up time, the catalyst concentration in the reactor and the ethylene conversion and is expressed in l/(mmol*min).
Average polymerization rate (Kp)=(Q/(100−Q)).times.(1/[TM]).times.(1/HUT),
where:

Q is the percent ethylene conversion;

[TM] is the catalyst concentration in the reactor expressed in mM; and

HUT is the reactor hold-up time in minutes.

The polymerizations were conducted at a temperature of 190° C.

The catalyst used in all experiments was cyclopentadienyl titanium (tri-tertiary butyl phosphinimine) dichloride, or CpTi[NP(tBu)₃]Cl₂. This catalyst is referred to as “C” in the accompanying tables.

A commercially available modified methylaluminoxane (“MMAO-7”, from Akzo-Nobel) was used in the examples and is referred to as “A1” in the tables. This MMAO-7 typically contains about 25 mole % of “associated” trimethylaluminum (i.e. for every 4 total moles of aluminum in MMAO-7, about 3 moles are contained in oligomeric MAO and about 1 mole is present as associated TMA). It has been observed that the addition of a hindered phenol (such as 2,6 di-tertiary butyl, 4-ethyl phenol or “BHEB”) in amounts up to a molar equivalence with the free TMA in the MAO, will typically improve the stability and activity of laboratory polymerizations, which use MMAO-7 as a cocatalyst. Accordingly, BHEB was used in some of the following experiments. BHEB is referred to by the code “D” in the following tables.

The screening runs that were used to test the modifiers involved constant conditions with the exception of the amount and identity of the modifier being tested. The conditions used for the screening runs were: C=4 μM, A1=800 μM, reactor temperature=190° C., ethylene=3.5 g/min, ethylene/octene=0.9 g/g, total flow=27 mL/min in a 70 mL reactor (where C and A1 are defined below).

The screening conditions are quite severe, particularly with respect to reactor residence time (of less than 3 minutes). Under these conditions it is generally accepted that the use of a simple aluminum alkyl as a cocatalyst (with or without the addition of a halogenated phenol modifier) will not provide sufficient catalyst activity to permit stable reactor operation.

The components of the catalyst systems used in this study include:

C: CpTi[NP(tBu)₃]Cl₂

A1: MMAO-7

D: BHEB(2,6-di-t-Butyl-4-ethylphenol)

C₆F₅OH: Pentafluorophenol

M: A wide variety of commercially available fluorinated organics were tested as modifiers, and some alternative aluminoxanes were also used. See Table A below.

To begin with, screening/optimization experiments were conducted using a non-halogenated phenol(2,6,di-t-butyl-4-ethyl phenol or “BHEB”) and pentafluorophenol.

A maximum Kp of 508 was observed using BHEB, at Al/Ti mole ratio=200 and BHEB/Al mole ratio=0.3.

A maximum Kp of 1,590 was observed using C₆F₅OH, at Al/Ti mole ratio=200 and C₆F₅OH/Al mole ratio=0.40 (as shown in the table directly below).

| | C | Al/C | BHEB/Al | C₆F₅OH/Al | | Kp (L/mmol |
|---|---|---|---|---|---|---|
| Run # | umol/L | (mol/mol) | (mol/mol) | (mol/mol) | % Q | Ti · min) |
| 1 | 5.81 | 200 | 0.30 | 0 | 88.4 | 508 |
| 2 | 2.94 | 200 | 0.15 | 0.15 | 88.7 | 1026 |
| 3 | 2.29 | 200 | 0 | 0.40 | 90.4 | 1590 |

Conditions 190° C., 3.5 g/min C2 and 0.5 g/g C8/C2.

Screening experiments were conducted with additional halogenated modifiers listed in Table A below.

Tables 1-11 provide comparative experimental data, which illustrate the efficiency of these modifiers in ethylene polymerizations.

The data in Tables 1-11 illustrate that the use of halogenated phenols is especially preferred for economic reasons (cost/activity relationships).

TABLE A
List of Modifiers Used

| M | Formula | Name |
|---|---|---|
| 1 | CF₃CHOH | Hexafluoroisopropanol |
| 2 | (2,4,6)-C₆H₂F₃—OH | 2,4,6-trifluorophenol |
| 3 | (2,3,5,6)-C₆F₄H—OH | 2,3,5,6-tetrafluorophenol |
| 4 | (CF₃)₂CO.H₂O | Hexafluoroacetone monohydrate |
| 5 | C₆F₅—COOH | Pentafluorobenzoic acid |
| 6 | C₆F₅—CH₂COOH | Pentafluoroacetic acid |
| 7 | C₆Cl₅—OH | Pentachlorophenol |
| 8 | 4-C₆FH₄—OH | 4-Fluorophenol |
| 9 | (2,5)-C₆F₂H₃—OH | 2,5,-Difluorophenol |
| 10 | (3,6)-C₆F₂H₃—OH | 3,6,-Difluorophenol |
| 11 | (CF₃)₃COH | Perfluoro-t-butanol |
| 12 | C₆F₅OH | Pentafluorophenol |

TABLE 1
Hexafluoroisopropanol Modifier

| | C | Al/C | M/Al | C8/C2 | C2 | | Kp (L/mmol |
|---|---|---|---|---|---|---|---|
| Run # | (umol/L) | (mol/mol) | (mol/mol) | (g/g) | (g/min) | % Q | Ti · min) |
| 1 | 4.0 | 200 | 0.20 | 0.90 | 3.5 | 82.9 | 467 |
| 2 | 4.0 | 200 | 0.30 | 0.90 | 3.5 | 77.8 | 336 |
| 3 | 4.0 | 200 | 0.10 | 0.90 | 3.5 | 86.3 | 607 |
| 4 | 4.0 | 200 | 0.05 | 0.90 | 3.5 | 82.7 | 458 |
| 5 | 4.0 | 200 | 0.08 | 0.90 | 3.5 | 86.1 | 594 |
| 6 | 4.0 | 200 | 0.09 | 0.90 | 3.5 | 86.2 | 602 |
| 7 | 4.0 | 200 | 0.10 | 0.90 | 3.5 | 77.6 | 332 |

TABLE 2
2,4,6-Trifluorophenol Modifier

| | C | Al/C | D/Al | M/Al | C8/C2 | C2 | | Kp (L/mmol |
|---|---|---|---|---|---|---|---|---|
| Run # | (umol/L) | (mol/mol) | (mol/mol) | (mol/mol) | (g/g) | (g/min) | % Q | Ti · min) |
| 1 | 4.0 | 200 | 0.125 | 0.20 | 0.90 | 3.5 | 70.1 | 226 |
| 2 | 4.0 | 200 | 0.125 | 0.30 | 0.90 | 3.5 | 26.9 | 35 |
| 3 | 4.0 | 200 | 0.125 | 0.10 | 0.90 | 3.5 | 84.2 | 512 |
| 4 | 4.0 | 200 | 0.125 | 0.05 | 0.90 | 3.5 | 80.8 | 404 |
| 5 | 4.0 | 200 | 0.125 | 0.10 | 0.90 | 3.5 | 78.0 | 341 |

TABLE 3
2,3,5,6-Tetrafluorophenol Modifier

| | C | Al/C | M/Al | C8/C2 | C2 | | Kp (L/mmol |
|---|---|---|---|---|---|---|---|
| Run # | (umol/L) | (mol/mol) | (mol/mol) | (g/g) | (g/min) | % Q | Ti · min) |
| 1 | 4.0 | 200 | 0.20 | 0.90 | 3.5 | 82.9 | 465 |
| 2 | 4.0 | 200 | 0.30 | 0.90 | 3.5 | 87.4 | 669 |
| 3 | 4.0 | 200 | 0.35 | 0.90 | 3.5 | 87.0 | 644 |
| 4 | 4.0 | 200 | 0.40 | 0.90 | 3.5 | 85.1 | 548 |
| 5 | 4.0 | 200 | 0.50 | 0.90 | 3.5 | 71.1 | 236 |

TABLE 4
Hexafluoroacetone Monohydrate Modifier

| | C | Al/C | D/Al | M/Al | C8/C2 | C2 | | Kp (L/mmol |
|---|---|---|---|---|---|---|---|---|
| Run # | (umol/L) | (mol/mol) | (mol/mol) | (mol/mol) | (g/g) | (g/min) | % Q | Ti · min) |
| 1 | 4.0 | 200 | 0.125 | 0.10 | 0.90 | 3.5 | 38.1 | 59 |
| 2 | 4.0 | 200 | 0.125 | 0.15 | 0.90 | 3.5 | 11.5 | 13 |
| 3 | 4.0 | 200 | 0.125 | 0.05 | 0.90 | 3.5 | 75.7 | 299 |

TABLE 5
Pentafluorobenzoic Acid Modifier

| | C | Al/C | D/Al | M/Al | C8/C2 | C2 | | Kp (L/mmol |
|---|---|---|---|---|---|---|---|---|
| Run # | (umol/L) | (mol/mol) | (mol/mol) | (mol/mol) | (g/g) | (g/min) | % Q | Ti · min) |
| 1 | 4.0 | 200 | 0.13 | 0.20 | 0.90 | 3.5 | 51.1 | 101 |
| 2 | 4.0 | 200 | 0.13 | 0.30 | 0.90 | 3.5 | 18.0 | 21 |
| 3 | 4.0 | 200 | 0.13 | 0.10 | 0.90 | 3.5 | 74.5 | 280 |
| 4 | 4.0 | 200 | 0.13 | 0.15 | 0.90 | 3.5 | 62.0 | 157 |

TABLE 6
Pentafluorophenyl Acetic Acid Modifier

| | C | Al/C | D/Al | M/Al | C8/C2 | C2 | | Kp (L/mmol |
|---|---|---|---|---|---|---|---|---|
| Run # | (umol/L) | (mol/mol) | (mol/mol) | (mol/mol) | (g/g) | (g/min) | % Q | Ti · min) |
| 1 | 4.0 | 200 | 0.125 | 0.20 | 0.90 | 3.5 | 42.0 | 70 |
| 2 | 4.0 | 200 | 0.125 | 0.30 | 0.90 | 3.5 | 0 | 0 |
| 3 | 4.0 | 200 | 0.125 | 0.35 | 0.90 | 3.5 | 0 | 0 |
| 4 | 4.0 | 200 | 0.125 | 0.10 | 0.90 | 3.5 | 66.0 | 187 |
| 5 | 4.0 | 200 | 0.125 | 0.05 | 0.90 | 3.5 | 76.6 | 314 |

TABLE 7
Pentachlorophenol Modifier

| | C | Al/C | D/Al | M/Al | C8/C2 | C2 | | Kp (L/mmol |
|---|---|---|---|---|---|---|---|---|
| Run # | (umol/L) | (mol/mol) | (mol/mol) | (mol/mol) | (g/g) | (g/min) | % Q | Ti · min) |
| 1 | 4.0 | 200 | 0.125 | 0.20 | 0.90 | 3.5 | 81.2 | 414 |
| 2 | 4.0 | 200 | 0.125 | 0.30 | 0.90 | 3.5 | 82.5 | 454 |
| 3 | 4.0 | 200 | 0.125 | 0.35 | 0.90 | 3.5 | 83.3 | 480 |
| 4 | 4.0 | 200 | 0.125 | 0.40 | 0.90 | 3.5 | 84.1 | 507 |
| 5 | 4.0 | 200 | 0.125 | 0.50 | 0.90 | 3.5 | 84.6 | 529 |
| 6 | 4.0 | 200 | 0.125 | 0.60 | 0.90 | 3.5 | 84.0 | 505 |
| 7 | 4.0 | 200 | 0.125 | 0.70 | 0.90 | 3.5 | 83.4 | 483 |
| 8 | 4.0 | 200 | 0 | 0.50 | 0.90 | 3.5 | 78.3 | 348 |

TABLE 8
4-Fluorophenol Modifier

| | C | Al/C | M/Al | C8/C2 | C2 | | Kp (L/mmol |
|---|---|---|---|---|---|---|---|
| Run # | (umol/L) | (mol/mol) | (mol/mol) | (g/g) | (g/min) | % Q | Ti · min) |
| 1 | 4.0 | 200 | 0.20 | 0.90 | 3.5 | 80.6 | 401 |
| 2 | 4.0 | 200 | 0.30 | 0.90 | 3.5 | 77.5 | 332 |
| 3 | 4.0 | 200 | 0.35 | 0.90 | 3.5 | 10.0 | 11 |
| 4 | 4.0 | 200 | 0.15 | 0.90 | 3.5 | 79.5 | 372 |
| 5 | 4.0 | 200 | 0.18 | 0.90 | 3.5 | 81.0 | 409 |
| 6 | 4.0 | 200 | 0.20 | 0.90 | 3.5 | 81.4 | 422 |
| 7 | 4.0 | 200 | 0.25 | 0.90 | 3.5 | 82.3 | 448 |
| 8 | 4.0 | 200 | 0.30 | 0.90 | 3.5 | 77.1 | 323 |

TABLE 9
2,6-Difluorophenol Modifier

| | C | Al/C | M/Al | C8/C2 | C2 | | Kp (L/mmol |
|---|---|---|---|---|---|---|---|
| Run # | (umol/L) | (mol/mol) | (mol/mol) | (g/g) | (g/min) | % Q | Ti · min) |
| 1 | 4.0 | 200 | 0.20 | 0.90 | 3.5 | 76.6 | 315 |
| 2 | 4.0 | 200 | 0.30 | 0.90 | 3.5 | 54.8 | 116 |
| 3 | 4.0 | 200 | 0.15 | 0.90 | 3.5 | 77.7 | 335 |
| 4 | 4.0 | 200 | 0.18 | 0.90 | 3.5 | 77.4 | 329 |
| 5 | 4.0 | 200 | 0.20 | 0.90 | 3.5 | 76.7 | 316 |

TABLE 10
3,5-Difluorophenol Modifier

| | C | Al/C | M/Al | C8/C2 | C2 | | Kp (L/mmol |
|---|---|---|---|---|---|---|---|
| Run # | (umol/L) | (mol/mol) | (mol/mol) | (g/g) | (g/min) | % Q | Ti · min) |
| 1 | 4.0 | 200 | 0.20 | 0.90 | 3.5 | 84.3 | 516 |
| 2 | 4.0 | 200 | 0.30 | 0.90 | 3.5 | 84.2 | 511 |

TABLE 11
Perfluoro-t-butanol Modifier

| | C | Al/C | D/Al | M/Al | C8/C2 | C2 | | Kp (L/mmol |
|---|---|---|---|---|---|---|---|---|
| Run # | (umol/L) | (mol/mol) | (mol/mol) | (mol/mol) | (g/g) | (g/min) | % Q | Ti · min) |
| 1 | 4.0 | 200 | 0.125 | 0.05 | 0.90 | 3.5 | 90.7 | 934 |
| 2 | 4.0 | 200 | 0.125 | 0.08 | 0.90 | 3.5 | 91.4 | 1018 |
| 3 | 4.0 | 200 | 0.125 | 0.09 | 0.90 | 3.5 | 91.0 | 966 |
| 4 | 4.0 | 200 | 0.125 | 0.10 | 0.90 | 3.5 | 90.8 | 948 |
| 5 | 4.0 | 200 | 0 | 0.08 | 0.90 | 3.5 | 89.4 | 809 |
| 6 | 4.0 | 200 | 0 | 0.10 | 0.90 | 3.5 | 90.3 | 898 |
| 7 | 4.0 | 200 | 0 | 0.13 | 0.90 | 3.5 | 90.8 | 943 |
| 8 | 4.0 | 200 | 0 | 0.15 | 0.90 | 3.5 | 88.8 | 765 |

### Example B

### Comparative

The results from Comparative Example A show the utility of C₆F₅OH. Accordingly, this modifier was tested under larger scale, dual reaactor polymerization conditions.

Table B.1 illustrates the process conditions used in this example, with a dual reactor solution process. Both reactors are steam jackets and controlled to produce essentially adiabatic conditions. Both reactors were agitated to produce well-mixed conditions. The volume of the first reactor was 12 liters and the volume of the second reactor was 24 liters. The first reactor was operated at the relatively low reactor pressure of about 13,000 kPa (about 2.0×10³ psi). The second reactor was at sufficiently lower pressure to facilitate continuous flow from the first reactor to the second. The solvent used was methyl pentane. The process is continuous in all feed streams.

The catalyst used in all experiments was a titanium (IV) complex having one cyclopentadienyl ligand, two chloride ligands and one tri(tertiary butyl)phosphinimine ligand, CpTiNP(t-Bu)₃Cl₂.

The cocatalysts components included commercially available methylalumoxane, BHEB and C₆F₅OH. More specifically, the methylalumoxane was “MMAO-7” available from Akzo-Nobel. The physical properties of the resulting resins are shown in Table B.2 as Examples B.2 and B.3.

TABLE B.1
Process Conditions

| | Example | | |
|---|---|---|---|
| | B.1 | B.2 | B.3 |
| Reactor 1 | | | |
| Ethylene (kg/h) | 27.3 | 26.9 | 41.3 |
| Hydrogen (g/h) | 0.72 | 0.55 | 0.29 |
| 1-Octene (kg/h) | 9.8 | 9.6 | 62.3 |
| Total Solution Rate (kg/h) | 278.6 | 273.6 | 425 |
| Reactor Inlet Temperature (° C.) | 32.5 | 31.9 | 30.0 |
| Reactor Temperature (° C.) | 151.8 | 154.3 | 142.2 |
| CpTiNP(t-Bu)₃Cl₂ to Reactor (PPM) | 0.35 | 0.11 | 0.10 |
| Al/Ti (mol/mol) | 200 | 2356 | 2142 |
| C₆F₅OH/Al (mol/mol) | 0.5 | 0.35 | 0.35 |
| Reactor 2 | | | |
| Ethylene (kg/h) | 63.7 | 62.6 | 41.3 |
| Hydrogen (g/h) | 4.5 | 3.25 | 1.45 |
| 1-Octene (kg/h) | 0 | 0 | 0 |
| Reactor Inlet Temperature (° C.) | 31.6 | 31.2 | 37.6 |
| Reactor Temperature (° C.) | 189.8 | 190.7 | 190 |
| CpTiNP(t-Bu)₃Cl₂ to Reactor (PPM) | 0.70 | 0.70 | 0.70 |
| Al/Ti (mol/mol) | 200 | 0 | 0 |
| C₆F₅OH/Al (mol/mol) | 0.35 | 0 | 0 |
| Totals (Reactor 1 and 2) | | | |
| Solution Rate (kg/h) | 650 | 650 | 650 |
| CpTiNP(t-Bu)₃Cl₂ to Reactor (PPM) | 0.85 | 0.75 | 0.76 |
| Al from MAO (PPM) | 11.5 | 7.2 | 9.1 |
| Reactor 1 | | | |
| Ethylene (kg/h) | 27.3 | 26.9 | 41.3 |
| Hydrogen (g/h) | 0.72 | 0.55 | 0.29 |

TABLE B.2
Resin Properties

Example

| | B.1 | B.2 | B.3 |
|---|---|---|---|
| Density | NM | 0.9373 | 0.9163 |
| Melt Index | NM | 3.40 | 0.82 |
| S. Ex | NM | 1.17 | 1.25 |

NM = not measured

Example 1 and 2 show that when MAO and C₆F₅OH are added to Reactor 1 only instead of both Reactor 1 and Reactor 2, the total amount of CpTiNP(t-Bu)₃Cl₂ and MAO for essentially the same process conditions is reduced.

### Example C

### Inventive

Examples A and B illustrate that halogenated phenol may be successfully used to improve the activity of MAO-cocatalyzed olefin polymerizations under both single and dual reactor configurations.

However, even under the preferred dual reactor conditions of Example B, the amount of expensive MAO required is still comparatively high.

This example illustrates that further optimization may be achieved by adding both aluminum alkyl and halogenated phenol to the polymerization, thereby reducing MAO cost.

Results are shown in Table C.

TABLE C

| | MAO(Al)/C | TMA/C | Al/C | | | Kp (L/mmol |
|---|---|---|---|---|---|---|
| Run # | (mol/mol) | (mol/mol) | (TOTAL) | C₆F₅OH/Al | % Q | Ti · min) |
| 1 | 200 | 0 | 200 | 0.40 | 94.4 | 1612 |
| 2 | 167 | 33 | 200 | 0.60 | 94.6 | 1698 |
| 3 | 240 | 0 | 240 | 0.45 | 94.9 | 1797 |
| 4 | 200 | 40 | 240 | 0.60 | 95.1 | 1858 |

TMA = trimethyl aluminum, moles
MAO(Al) = moles of aluminum in MAO

What is claimed is:

1. A cocatalyst system for olefin polymerization comprising:
1) methylaluminoxane having a molar aluminum concentration of A1;
2) additional aluminum alkyl in a molar amount A2, wherein said aluminum alkyl is defined by the formula Al(R)ₐ(OR)_{b}Xₓ;
wherein each R and R¹ is a C_{1 to 10} hydrocarbyl;
X is a halide; and
a+b+c=3 with the provisos that a≧2 land A2<A1; and
3) a halogenated phenol.

2. The cocatalyst system according to claim 1 wherein said halogenated phenol is present in a molar amount hP1 defined by the formula:
0.45A1+3A2≧hP1≧0.25A1

3. The cocatalyst system according to claim 1 wherein said halogenated phenol is present in a molar amount hP1 is defined by the formula:
0.45A1+3A2≧hP1≧0.4A1

4. The cocatalyst system according to claim 1 wherein said aluminum alkyl is selected from the group consisting of trimethylaluminum, triethylaluminum, and triisobutyl aluminum.

5. The cocatalyst system according to claim 1 wherein the mole ratio of A2/A1 is from 0.1/1 to 0.5/1.

6. The cocatalyst system according to claim 1 wherein said halogenated phenol is C₆F₅OH.

7. A catalyst system for olefin polymerization comprising (A) a group 3-10 metal catalyst; and (B) a catalyst activator system comprising a cocatalyst system for olefin polymerization comprising:
1) methylaluminoxane having a molar alumina concentration of A1;
2) additional aluminum alkyl in a molar amount A2, wherein said aluminum alkyl is defined by the formula Al(R)ₐ(OR)_{b}X_{c};
wherein each R and R¹ is a C_{1 to 10} hydrocarbyl;
X is a halide; and
a+b+c=3 with the provisos that a≧1and A2<A1; and
3) a halogenated phenol.

8. The catalyst system according to claim 7 wherein said halogenated phenol is present in a molar amount hP1 defined by the formula:
0.45A1+3A2≧hP1≧0.25A1

9. The catalyst system according to claim 7 wherein said metal is a group 4 metal selected from the group consisting of titanium, zirconium and hafnium.

10. The catalyst system according to claim 9 wherein said metal catalyst contains at least one delocalized pi bonded ligand.

11. A process for olefin polymerization comprising contacting the catalyst system of claim 7 with at least one C₂ to C₈ alpha olefin under polymerization conditions.

12. The process according to claim 11 wherein said at least one olefin comprises ethylene and at least one C₃ to C₁₀ alpha olefin.

13. The process according to claim 11 wherein said polymerization conditions comprise solution polymerization conditions at a temperature of from 30° C. to 280° C.
